(19) United States
(12) Patent Application Publication
(10) Pub. No.: US 2025/0002786 A1
(43) Pub. Date: Jan. 2, 2025

(54) LIQUID CRYSTAL ELASTOMER PRECURSOR SOLUTION MATERIAL AND PHOTOPOLYMERIZATION APPARATUS FOR PREPARING LIQUID CRYSTAL ELASTOMER WITH THE SAME

(71) Applicant: Seoul National University R&DB Foundation, Seoul (KR)

(72) Inventors: Howon LEE, Seoul (KR); Sehui JEONG, Seoul (KR)

(73) Assignee: Seoul National University R&DB Foundation, Seoul (KR)

(21) Appl. No.: 18/695,398

(22) PCT Filed: May 25, 2023
(86) PCT No.: PCT/KR2023/007180

§ 371 Date: Mar. 26, 2024

(30) Foreign Application Priority Data
May 26, 2022 (KR) 10-2022-0064824

(51) Int. Cl. C09K 19/12; B01J 19/08; B01J 19/12

(52) U.S. Cl. CPC C09K 19/12; B01J 19/087; B01J 19/122; B01J 2219/0803; B01J 2219/1203; C09K 2019/122

(57) ABSTRACT

Disclosed are a liquid crystal elastomer precursor solution material and a photopolymerization apparatus for preparing a liquid crystal elastomer with the solution material, in which the liquid crystal elastomer precursor solution material includes photocurable reactive mesogen, EDDET (2,2′-(ethylenedioxy)diethanethiol), and 5CB (4-cyano-4-pentylbiphenyl).

### TECHNICAL FIELD

The disclosure relates to a liquid crystal elastomer precursor solution material and a photopolymerization apparatus for preparing a liquid crystal elastomer (LCE) with the same solution material, and more particularly to an LCE precursor solution material, which has an appropriate viscosity at room temperature and maintains a nematic state to quickly orient liquid crystals in a magnetic field at room temperature without a heating or temperature control cycle, and a photopolymerization apparatus for preparing the LCE by applying magnetic field and light to the solution material.

### BACKGROUND ART

4D printing, which combines 3D printing with a smart material, has been in the limelight since its concept was introduced several years ago. A hydrogel and a shape memory polymer (SMP) have been widely used as the smart materials that are changed in shape and properties in response to various external stimuli. The hydrogel has an advantage that its change in shape is reversible, but has problems that not only its practical application is limited due to low mechanical strength but also it should be used together with a solvent such as water. In addition, the SMP does not require the use of the solvent, but has a disadvantage that its change in shape is irreversible. On the other hand, a liquid crystal elastomer (LCE), which has recently been attracting attention as the smart material, has advantages over the hydrogel and the SMP, in particular, that it does not require the use of the solvent such as water and its change in shape is reversible.

A liquid crystal polymer refers to a polymer that can exhibit the properties of liquid crystal as liquid crystal molecules are connected to a polymer chain. In particular, a polymer that has flexible properties as elastomer molecules are connected to liquid crystal molecules and exhibits reversible change in a liquid crystal phase at low temperature is called the LCE. The liquid crystal molecules have anisotropy with different lengths of long and short axes, and the LCE is prepared by chemical cross-linking the liquid crystal molecules of which the long axes are oriented (arranged) in one direction. The oriented liquid crystal molecules become disordered causing macroscopic shrinkage when heated above a certain temperature, and return to their original shape as the initial orientation of the liquid crystal molecules is recovered by the elasticity of the cross-linked elastomer when the temperature is lowered again. Such bidirectional self-transforming properties have been applied to various fields such as artificial muscles, soft robots, and biomechanics. Because the transformation occurs in the initial orientation direction of the liquid crystal molecules, it is important for LCE preparing techniques to take the orientation of liquid crystal molecules into account.

For orienting the liquid crystals in the LCE, various methods have been reported such as mechanical stretching method, surface orientation method, and methods using magnetic and electric fields. In particular, the method using the magnetic field has a great advantage in that contactless orientation from a distance is allowed. However, there is a significant limitation to the application of this method because a relatively strong magnetic field (100 mT to 500 mT) is required to align liquid crystal molecules. To generate a magnetic field in space, a Helmholtz coil is often used. The Helmholtz coil may be effective in generating a magnetic field with a strength of approximately 10 mT to 50 mT. However, when generating the magnetic field with a higher strength, the Helmholtz coil becomes very bulky and needs an additional cooling device to solve high heat generation.

Further, a conventional method of using a permanent magnet has a problem that it takes a long time to prepare the LCE because the material is heated to a high temperature to enter a nematic state and then cooled at a very slow rate for approximately 1 hour or more to orient the liquid crystals due to the nature of a material used in the preparation. In addition, when the LCE is prepared in multiple layers, it takes too much time to prepare the LCE.

### PATENT DOCUMENT

Korean Patent No. 10-2127590

### DISCLOSURE

### Technical Problem

Therefore, the disclosure has been conceived to solve the foregoing problems, and an aspect of the disclosure is to provide a liquid crystal elastomer (LCE) precursor solution material that maintains a liquid crystal nematic state at room temperature and maintains appropriate fluidity so that liquid crystals can be oriented by a magnetic field within a few seconds at room temperature without temperature rising to higher temperatures or temperature control cycling, which can subsequently be patterned into a desired shape.

Another aspect of the disclosure is to provide a photopolymerization apparatus for preparing an LCE, in which liquid crystals can be locally oriented in any three-dimensional direction and independently patterned by a digital light projector (DLP) integrated with a magnetic field generator capable of switching a direction of a magnetic field.

Problems to be solved in the disclosure are not limited to the forementioned problems, and other unmentioned technical problems can be clearly understood from the following description by those skilled in the art.

### Technical Solution

According to an embodiment of the disclosure, a liquid crystal elastomer (LCE) precursor solution material includes photocurable reactive mesogen, EDDET (2,2′-(ethylenedioxy)diethanethiol), and 5CB (4-cyano-4-pentylbiphenyl).

Here, the photocurable reactive mesogen may include either RM257 (1,4-Bis-[4-(3-acryloyloxypropyloxy)benzoyloxy]-2-methylbenzene) or RM82 (1,4-Bis-[4-(6-acryloyloxyhexyloxy)benzoyloxy]).

Here, the LCE precursor solution material may be prepared by dissolving powder of the photocurable reactive mesogen in solution of the 5CB at a temperature above room temperature, cooling the solution to room temperature, and adding the EDDET to the solution.

Here, the LCE precursor solution material may further include a photo-initiator (PI) and a photo-absorber (PA).

According to another embodiment of the disclosure, a photopolymerization apparatus for preparing a liquid crystal elastomer includes: a magnet disposed around the foregoing liquid crystal elastomer precursor solution material, and forming a magnetic field in liquid crystal elastomer precursor solution material to orient liquid crystal molecules; a driver driving the magnet to control a direction of the magnetic field; and a light source irradiating the liquid crystal elastomer precursor solution material with light to cure the liquid crystal elastomer precursor solution material by a photopolymerization reaction.

Here, the magnet may include a pair of magnets disposed to face each other with the liquid crystal elastomer precursor solution material therebetween.

Here, the driver may include a rotary table on which the pair of magnets are horizontally disposed to face each other; and a rotary driver by which the rotary table is rotated.

Here, the driver may further include a distance controller to control a distance between the pair of magnets by moving at least one of the pair of magnets horizontally.

Here, the driver may drive the magnet to control the direction of the magnetic field formed in the liquid crystal elastomer precursor solution material in a three-dimensional direction.

Here, the driver may include: a rotary table; a rotary driver by which the rotary table is rotated; and a rotation driver by which a plurality of magnets placed above the rotary table and disposed around an axis perpendicular to a rotation axis of the rotary table is driven to rotate.

Here, the magnets may be disposed equidistantly along a circumferential direction.

Here, the magnets may have a rotation axis disposed parallel to the axis perpendicular to the rotation axis of the rotary table.

Here, the rotation driver may include: a worm gear disposed horizontally and rotating by power received from a power source; a worm wheel which rotates being engaged with the worm gear; and a plurality of rotation gears which rotate being engaged with a gear train formed inside a through hole of the worm wheel and respectively couple with the magnets.

Here, the photopolymerization apparatus may further include a digital micromirror device (DMD) and a digital mask to form a pattern by selectively reflecting the light irradiated from the light source toward the liquid crystal elastomer precursor solution material.

### Advantageous Effects

As described above, a liquid crystal elastomer (LCE) precursor solution material according to the disclosure has advantages that it can have an appropriate viscosity and maintain a nematic state at room temperature so that the LCE can be prepared by quickly orienting liquid crystals in a magnetic field at room temperature without heating or cooling.

Further, an LCE preparing apparatus according to the disclosure has advantages that an orientation direction of liquid crystals is not dependent on a printing direction, and curing based on a photopolymerization reaction and orientation direction control based on a magnetic field are independently controlled to prepare the LCE.

In addition, an LCE preparing apparatus according to the disclosure has advantages that a magnetic field is controlled in not only a two-dimensional direction but also a three-dimensional direction to control an orientation direction of liquid crystals.

### DESCRIPTION OF DRAWINGS

FIG. 1 illustrates the composition of a liquid crystal elastomer (LCE) precursor solution material according to an embodiment of the disclosure.

FIG. 2 illustrates a schematic configuration of a photopolymerization apparatus for preparing an LCE according to an embodiment of the disclosure.

FIG. 3 shows pure RM257 and RM257 mixed with 5CB in a weight ratio of 1:1 according to the disclosure, the states of which are varied depending on temperatures.

FIG. 4 illustrates that a petal-shaped pattern is formed by independently performing the orientation of liquid crystals and the formation of a pattern through the apparatus of FIG. 2.

FIG. 5 shows experimental results of orienting liquid crystals in an LCE film prepared according to the disclosure viewed through a polarized optical microscope.

FIG. 6 illustrates a reversible reaction of an LCE prepared according to the disclosure.

FIG. 7 shows experimental results of performance of an LCE according to periods of exposure time to a magnetic field while the LCE according to the disclosure is prepared.

FIG. 8 illustrates orientation directions with respect to a lengthwise direction of a pattern when an LCE according to the disclosure is prepared, and

FIGS. 9 and 10 illustrate experimental results of liquid crystal orientation of which performance is affected by the strength of a magnetic field when the LCE is prepared by orienting liquid crystals in the lengthwise direction of the LCE or in a direction perpendicular to the lengthwise direction.

FIGS. 11 and 12 show experimental results of curing depths depending on the amount of light energy when an LCE according to the disclosure is prepared.

FIG. 13 illustrates an LCE film having a double-layered structure of a passive region and an active region according to the disclosure.

FIG. 14 shows various morphing structures having a double layer prepared according to the disclosure and their thermal transformation.

FIG. 15 shows morphing structures having a double layer and shaped like a flower, petals of which are different in an orientation direction of liquid crystals, according to the disclosure and their thermal transformation.

FIG. 16 illustrates a driver having a structure for horizontally rotating a pair of opposing magnets according to an embodiment of the disclosure.

FIGS. 17 and 18 are perspective views of a driver for changing the direction of a magnetic field in a three-dimensional space according to another embodiment of the disclosure.

FIG. 19 illustrates change in the direction of a magnetic field based on a rotating direction of a magnet.

### BEST MODE

Specific features of embodiments are involved in the detailed description and the accompanying drawings.

The merits and features of the disclosure, and methods of achieving them will become apparent with reference to the embodiments described below in detail and the accompanying drawings. However, the disclosure is not limited to the embodiments set forth herein, but may be implemented in various forms. The following embodiments are provided in order to fully describe the disclosure and enable those skilled in the art, to which the disclosure pertains, to understand the disclosure, the scope of which is defined in the appended claims. Like numerals refer to like elements throughout.

Below, a liquid crystal elastomer (LCE) precursor solution material according to embodiments of the disclosure and a photopolymerization apparatus for preparing an LCE with the same material will be described with reference to the accompanying drawings.

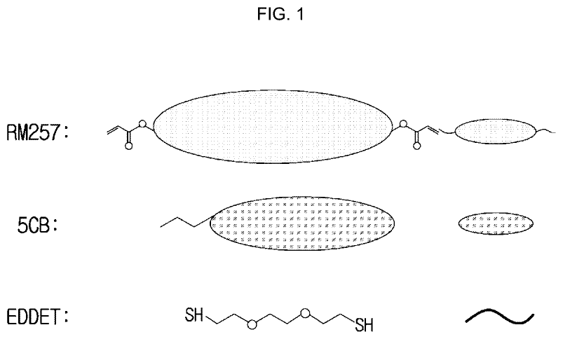

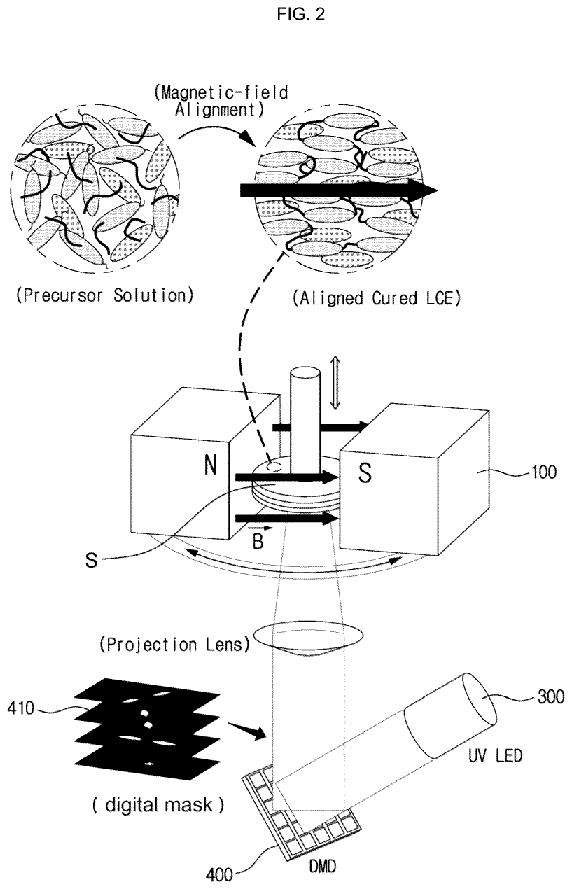

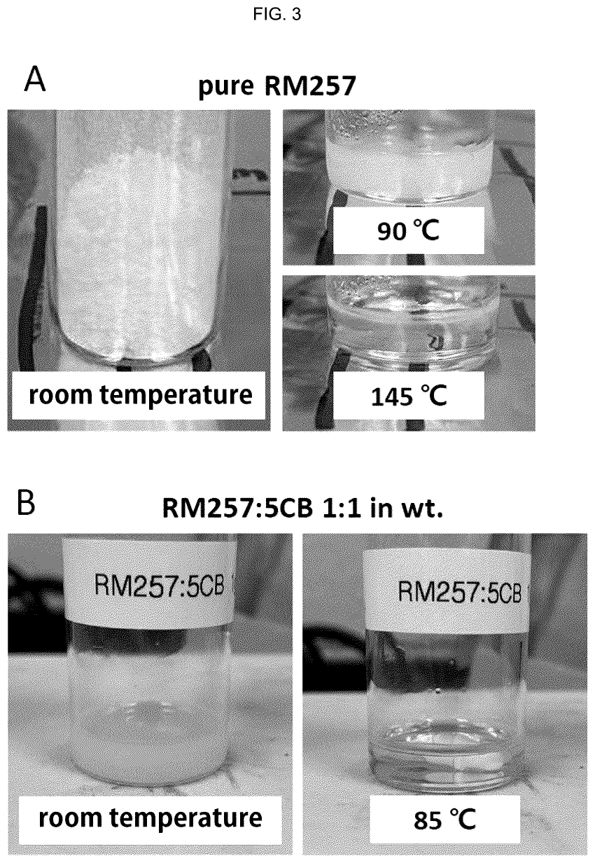

FIG. 1 illustrates the composition of a liquid crystal elastomer (LCE) precursor solution material according to an embodiment of the disclosure, FIG. 2 illustrates a schematic configuration of a photopolymerization apparatus for preparing an LCE according to an embodiment of the disclosure, and FIG. 3 shows pure RM257 and RM257 mixed with 5CB in a weight ratio of 1:1 according to the disclosure, the states of which are varied depending on temperatures.

As shown in FIG. 1, a LCE precursor solution material according to an embodiment of the disclosure may contain RM257 (1,4-Bis-[4-(3-acryloyloxypropyloxy)benzoyloxy]-2-methylbenzene), EDDET (2,2′-(ethylenedioxy) diethanethiol), and 5CB (4-cyano-4-pentylbiphenyl). When the LCE precursor solution material according to the disclosure is cured by an acrylate-thiol photopolymerization reaction, RM257 acts as a mesogenic diacrylate monomer and EDDET acts as a dithiol spacer.

In this embodiment, it will be described that RM257 is used as a mesogen. However, any photocurable reactive mesogen material comprising RM257 may be used as the mesogen. For example, RM82 (1,4-Bis-[4-(6-acryloyloxyhexyloxy)benzoyloxy]) may be used in addition to RM257.

Pure RM257 does not enter a nematic state unless it is heated to a temperature of 70° C. or higher. However, when RM257 is dissolved in 5CB, i.e., a non-reactive mesogenic solvent according to the disclosure, RM257 can maintain the nematic state at room temperature. Further, as shown in FIG. 3, pure RM257 undergoes a transition between the nematic state and an anisotropic state at a temperature of 130° C., but the mixture of RM275 and 5CB undergoes the transition at a temperature lower than 80° C.

In addition, the LCE precursor solution material according to an embodiment of the disclosure may further include a photo-initiator (PI) and a photo-absorber (PA) for the photopolymerization reaction. In this embodiment, phenylbis(2,4,6-trimethylbenzoyl) phosphine oxide may be used as the PI, and Sudan I may be used as the PA, but the PI and the PA are not limited thereto.

Below, a process of preparing a LCE precursor solution material according to the disclosure will be described by way of example in more detail.

First, 2 g of RM257 powder is dissolved in 2 g of 5CB solution (in a weight ratio of 1:1) by stirring at a temperature of 90° C. for 60 minutes. 0.02 g of the PI, i.e., Phenylbis(2,4,6-trimethylbenzoyl) phosphine oxide, and 0.002 g of the PA, i.e., Sudan I are added to the solution at a concentration of 1% and 0.1% by weight to RM257. After cooling the solution to room temperature, 0.3717 g of EDDET (at a concentration of 60 mol % over RM257) is added to the solution and stirred at room temperature for 10 minutes, and then stored in a brown vial bottle to complete the preparation.

The photopolymerization apparatus for preparing the LCE according to an embodiment of the disclosure using the forgoing LCE precursor solution material may include a magnet 100, a driver 200, and a light source 300.

The magnet 100 is disposed around the LCE precursor solution material and forms a magnetic field in the solution material, thereby orienting liquid crystal molecules in the solution material with the direction of the magnetic field.

In this case, the LCE precursor solution material may be injected between a glass substrates S through which light passes or into a container made of glass.

The magnet 100 forming the magnetic field may include a permanent magnet. Further, the magnet 100 may be provided as a pair of magnets of which opposite poles face each other, and the magnet 100 may be driven to rotate in a horizontal direction by the driver 200. Therefore, in the state that the LCE precursor solution material is disposed between the pair of magnets 100, the driver 200 may rotate the magnets 100 in the horizontal direction in order to freely control the direction of the magnetic field in a region where the LCE precursor solution material is located. Therefore, the liquid crystals are oriented with the direction of the magnetic field formed in the LCE precursor solution material.

In this embodiment, the direction of the magnetic field is controlled in the horizontal direction. However, according to another embodiment to be described later, the direction of the magnetic field may also be controlled in a three-dimensional direction, thereby orienting the liquid crystals in the three-dimensional direction.

The light source 300 irradiates the LCE precursor solution material with light so that the LCE precursor solution material can be cured by the photopolymerization reaction, thereby forming a pattern (shape). In this embodiment, an ultraviolet light emitting diode (UV LED) may be used as the light source 300. Further, there may be provided a digital micromirror device (DMD) 400 that selectively reflects light irradiated from the light source 300 toward the LCE precursor solution material in units of pixels, and a digital mask 410 formed with a pattern. Therefore, the light irradiated from the light source 300 is selectively reflected and transferred to the LCE precursor solution material through the DMD 400 and the digital mask 410 to cure the LCE precursor solution material in fine-sized units corresponding to the pattern of the digital mask 410, thereby easily forming a pattern even with complex shapes.

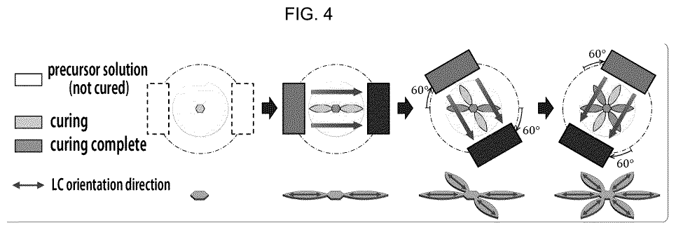

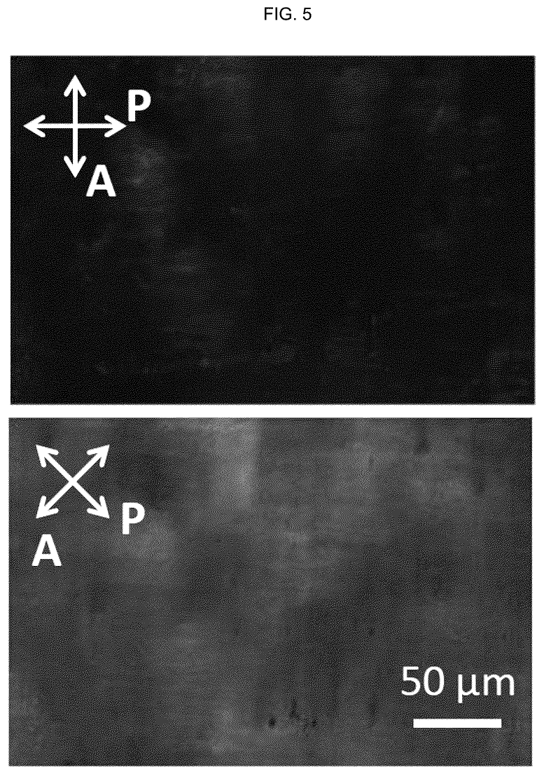

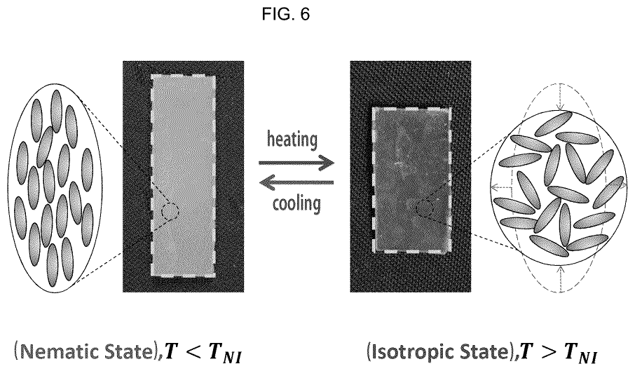

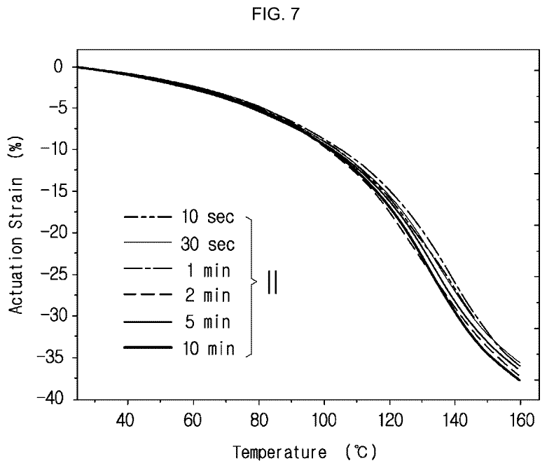

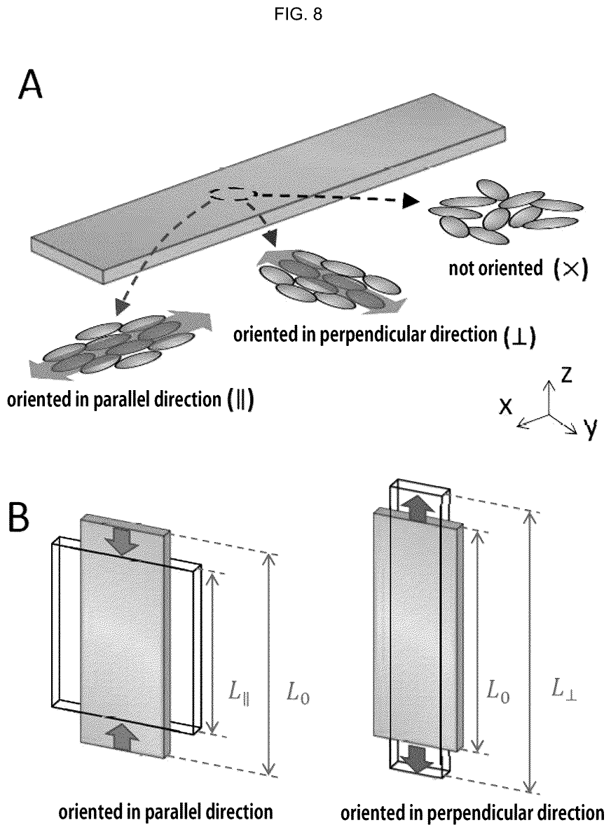

FIG. 4 illustrates that a petal-shaped pattern is formed by independently performing the alignment of liquid crystals and the formation of a pattern through the apparatus of FIG. 2, FIG. 5 shows experimental results of liquid crystal orientation in an LCE film produced according to the disclosure viewed through a polarized optical microscope, FIG. 6 illustrates a reversible reaction of an LCE produced according to the disclosure, FIG. 7 shows experimental results of performance of an LCE according to periods of exposure time to a magnetic field while the LCE according to the disclosure is produced, FIG. 8 illustrates orientation directions with respect to a lengthwise direction of a pattern when an LCE according to the disclosure is produced,

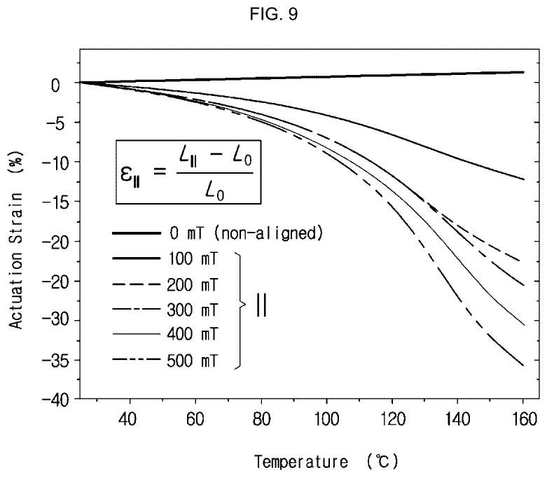

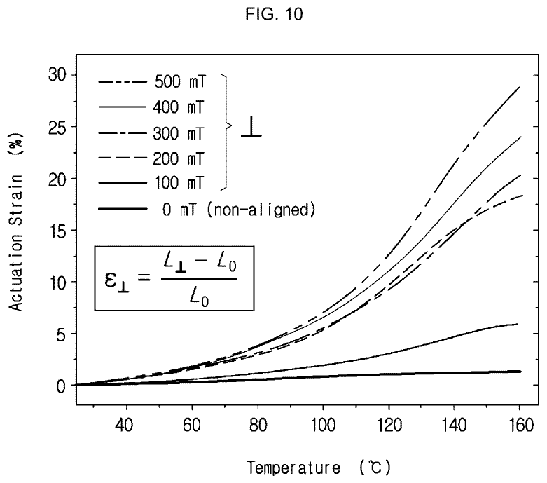

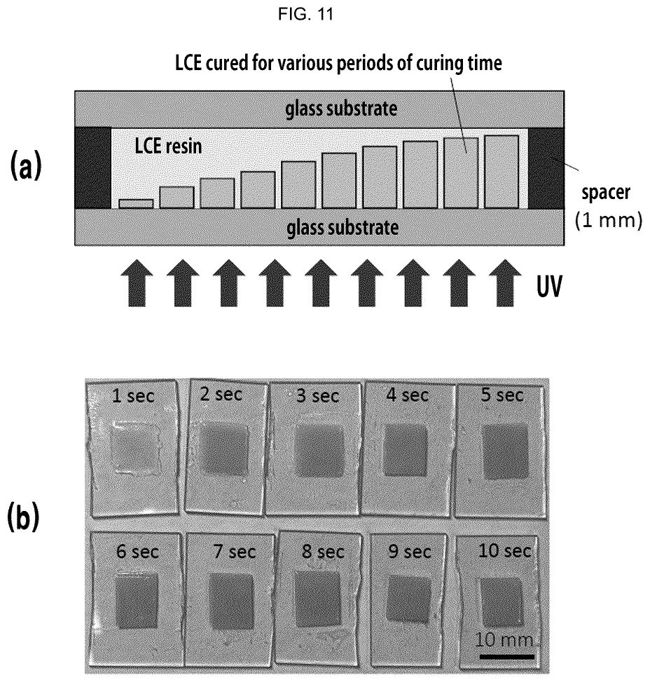

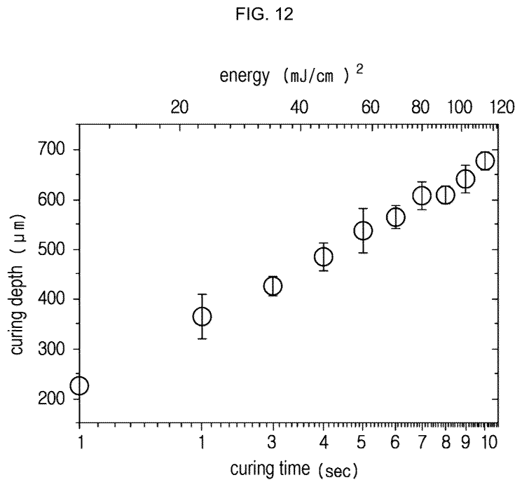

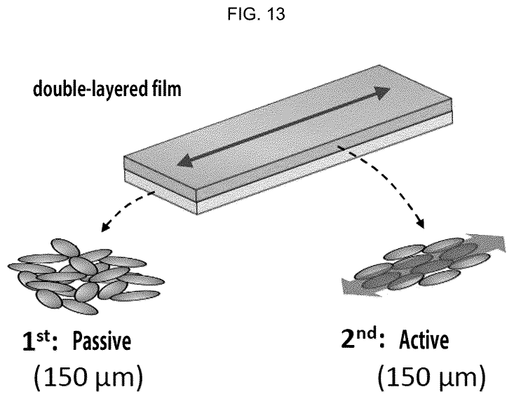

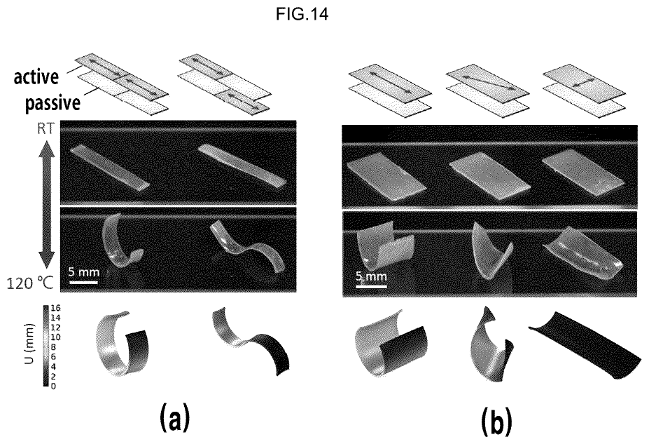

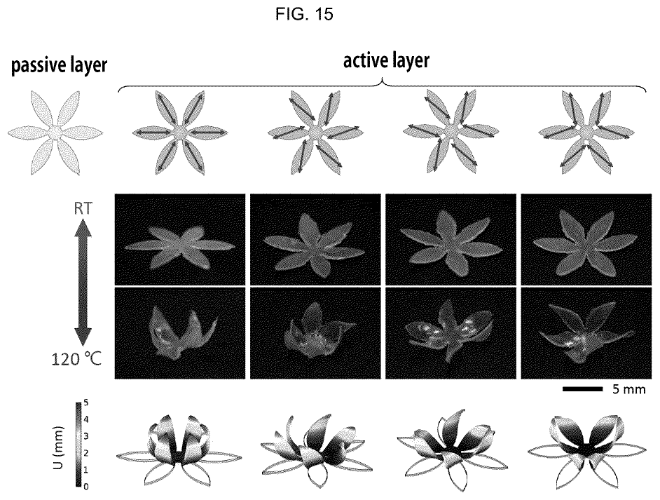

FIGS. 9 and 10 illustrate experimental results of liquid crystal orientation of which performance is affected by the strength of a magnetic field when the LCE is produced by orienting liquid crystals in the lengthwise direction of the LCE or in a direction perpendicular to the lengthwise direction, FIGS. 11 and 12 show experimental results of curing depths depending on the amount of light energy when an LCE according to the disclosure is produced, FIG. 13 illustrates an LCE film having a double-layered structure of a passive region and an active region according to the disclosure, FIG. 14 shows various morphing structures having a double layer according to the disclosure and their thermal transformation, FIG. 15 shows morphing structures having a double layer and shaped like a flower, petals of which are different in an orientation direction of liquid crystals, according to the disclosure and their thermal transformation.

In this way, the orientation of the liquid crystals by the magnet 100 and the formation of the pattern by photocuring according to the disclosure may be performed independently of each other. For example, as shown in FIG. 4, the core undergoes only the curing without the magnetic field to thereby form the center of petals, and three pairs of petals extending in opposite directions across the core are formed. In this case, when the three pairs of petals are prepared in sequence, light corresponding to the shape of each pair of petals is provided through the DMD 400 and the digital mask 410, and the position of the magnet 100 is controlled differently to form a magnetic field in the lengthwise direction of the petals, thereby orienting the liquid crystals in the lengthwise directions of the six petals.

FIG. 5 shows experimental results of liquid crystal orientation in an LCE film prepared according to the disclosure viewed through a polarizing optical microscope. As shown in the experimental results, a uniaxially oriented LCE film prepared according to the disclosure, of which the liquid crystal orientation is disposed parallel to one axis of a crossed polarizer, appears dark when viewed through the polarized optical microscope. When the crossed polarizer is rotated by 45 degrees, a brighter region appears due to the well-known properties of the liquid crystal, i.e., birefringence.

As shown in FIG. 6, the uniaxially oriented LCE film prepared according to the disclosure is in the nematic state, in which the liquid crystal molecules are all oriented in the same direction, at room temperature below a transition temperature T_{NI}, and enters an isotropic state, in which the liquid crystal molecules are out of the orientation, when heated above the transition temperature T_{NI}. When heated above the transition temperature T_{NI}, macroscopically, the film shrinks in the direction of the liquid crystal orientation but expands in the direction perpendicular to the liquid crystal orientation. On the other hand, when cooled back to room temperature, the film returns to its initial shape, thereby undergoing the reversible thermal transformation.

In the results of FIG. 7, it was tested that the performance of orienting the liquid crystals was affected by the periods of exposure time to the magnetic field. When the LCE prepared oriented according to the disclosure, of which the liquid crystals are all oriented in the same direction, is thermally transformed while changing the period of exposure time to the magnetic field from 10 seconds to 10 minutes before the curing based on ultraviolet light exposure, almost the same performances were obtained. From these results, it is seen that the liquid crystals are oriented according to the disclosure at room temperature within a very short period of time, thereby greatly improving a printing efficiency.

In the results of FIGS. 9 and 10, it was tested that the performance of orienting the liquid crystals was affected by the strength of the magnetic field when the LCE according to the disclosure was prepared by orienting the liquid crystals in a direction parallel or perpendicular to the lengthwise direction of an LCE pattern as shown in FIG. 8. As shown in FIG. 9, the film oriented parallel to the pattern showed negative shrinkage strain due to shrinkage, and actuation strain increases from −12.1% to −35.6% as the strength of the magnetic field increases from 100 mT to 500 mT. Likewise, as shown in FIG. 10, the film oriented perpendicular to the pattern showed expansion strain, and actuation strain increases from 5.9% to 29.0% as the strength of the magnetic field increases from 100 mT to 500 mT. Therefore, according to the disclosure, the magnitude of reversible thermal transformation is controllable by controlling the strength of the magnetic field when the liquid crystals are oriented.

As shown in FIGS. 11 and 12, when the LCE was prepared by injecting the LCE precursor solution material according to the disclosure between two glass substrates, and changing the period of exposure time to ultraviolet light (i.e., curing time) with the ultraviolet light having a certain intensity using the apparatus of FIG. 2, it is seen that the depth of curing increases in proportion to the period of exposure time to the ultraviolet light (i.e., the amount of light energy). Therefore, the printing thickness of a single layer is controllable by controlling the curing time.

As shown in FIG. 13, a double-layered LCE may be prepared. Of course, although it is not shown, a multi-layered LCE may also be printed and prepared by repeatedly preparing a single layered LCE according to the disclosure. In this case, a lower layer is cured without a magnetic field to form a passive region where the liquid crystals are not oriented, and an upper layer is cured with the liquid crystals oriented in one direction by a magnetic field to form an active region where the liquid crystals are oriented. In this way, the double-layered film is prepared according to the disclosure to form various thermal transformation morphing structures to be described with reference to FIGS. 14 and 15.

In (a) of FIG. 14, the left side shows a double-layered morphing structure in which a lower layer is formed to entirely have a passive region and an upper layer is formed to entirely have an active region where the liquid crystals are oriented in the lengthwise direction of the pattern. In (a) of FIG. 14, the right side shows a double-layered morphing structure in which each of lower and upper layers has half an active region and half a passive region, and the active region and the passive region of the lower layer are located differently from those of the upper layer. When the morphing structures prepared as shown in (a) of FIG. 14 are heated, the morphing structure shown on the left side is transformed to curl having a “C”-shape as the upper layer shrinks in the orientation direction of the liquid crystals, and the morphing structure shown on the right side is transformed to curl having an “S”-shape as the active regions of both the upper and lower layers shrink in the orientation direction of the liquid crystals.

Further, (b) of FIG. 14 shows double-layered morphing structures in which each lower layer is formed to entirely have the passive region and each upper layer is formed to entirely have the active region, and the upper layers are different in the orientation direction of liquid crystals. When the morphing structures prepared as shown in (b) of FIG. 14 are heated, the morphing structures are transformed to curl having various shapes as the shrinkage directions of the upper layers are varied depending on the orientation directions of liquid crystals.

FIG. 15 shows the results of thermal transformation applied to double-layered morphing structures formed with a lower passive layer and an upper active layer and shaped like a flower of which petals are different in an orientation direction of liquid crystals. As shown therein, it is seen that a shrinkage direction of the active layer is varied depending on the orientation direction of the liquid crystals. In this way, the morphing structures are thermally transformed to form flowers of various shapes.

As shown in FIGS. 14 and 15, the LCE according to the disclosure is prepared easily having a multi-layered structure divided into a passive region and an active region and allowing various orientation directions of liquid crystals, thereby having various patterns and being thermally transformed to have various shapes.

Below, the configuration of the driver 200, which controls the direction of the magnetic field by driving the magnet, in the photopolymerization apparatus for preparing the LCE according to the disclosure, will be described.

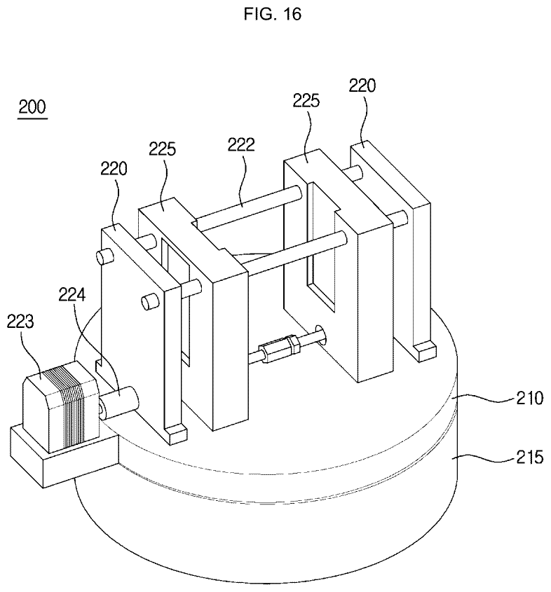

FIG. 16 illustrates a driver having a structure for horizontally rotating a pair of opposing magnets according to an embodiment of the disclosure.

The driver 200 may include a rotary table 210 and a rotary driver 215.

The pair of magnets 100 is disposed on the rotary table 210, and the rotary table 210 may be rotated by power received from the rotary driver 215. Therefore, the LCE precursor solution material according to the disclosure is placed in the middle between the pair of magnets 100, and the rotary table 210 is rotated by the driver 215 to horizontally control the direction of the magnetic field at the center where the LCE precursor solution material is located. In this way, the orientation direction of the liquid crystals is easily controlled by the magnetic field. Although it is not shown, the light source 300, the DMD 400, and the digital mask 410 are arranged on an upper side so that the light irradiated from the light source 300 can be selectively transferred to a fine area, in which the solution material is placed, through the DMD 400 and the digital mask 410, thereby forming a pattern by curing based on the photopolymerization reaction.

According to the disclosure, a distance controller may be formed to control the distance between the pair of magnets 100 by moving at least one of the pair of magnets 100 horizontally. Because the distance between the pair of magnets 100 is controllable by the distance controller, the strength of the magnetic field applied to the LCE precursor solution material placed in the middle between the pair of magnets 100 is also controllable for liquid crystal orientation.

In this embodiment, the distance controller may include supports 220 formed on top of the rotary table 210, at least one guide rod 222 connecting the supports 220, a ball-screw 224 rotating by power received from a motor 223, and magnet holding blocks 225 put on the guide rod 222 and holding the magnet 100. In this case, at least one of the magnet holding blocks 225 is movable along the guide rod 222. According to this embodiment, the magnet holding block 225 on the left side is configured to move horizontally along the guide rod 222 by the rotation of the ball-screw 224.

Therefore, the distance between the pair of magnets 100 is controllable by controlling the rotating direction of the motor 223 to move the left magnet holding block 225 in the horizontal direction. The distance controller for controlling the distance between the pair of magnets 100 is not limited to the illustrated configuration, but may have variously configurations.

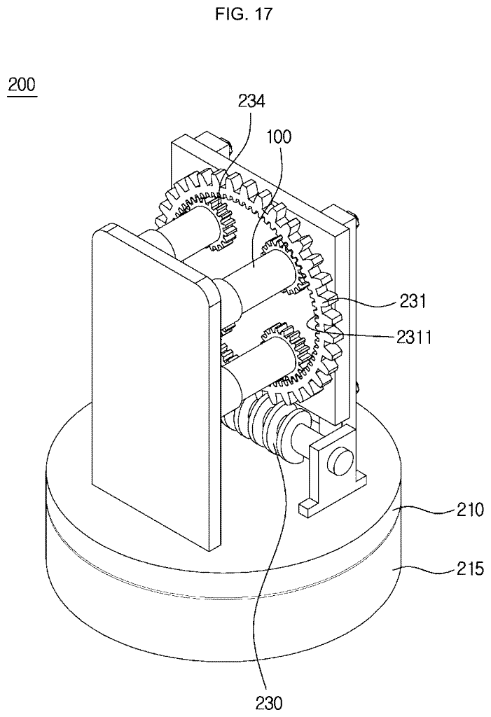

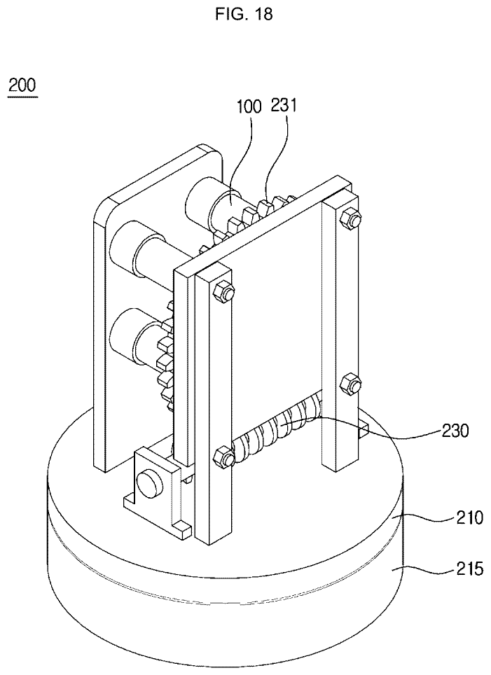

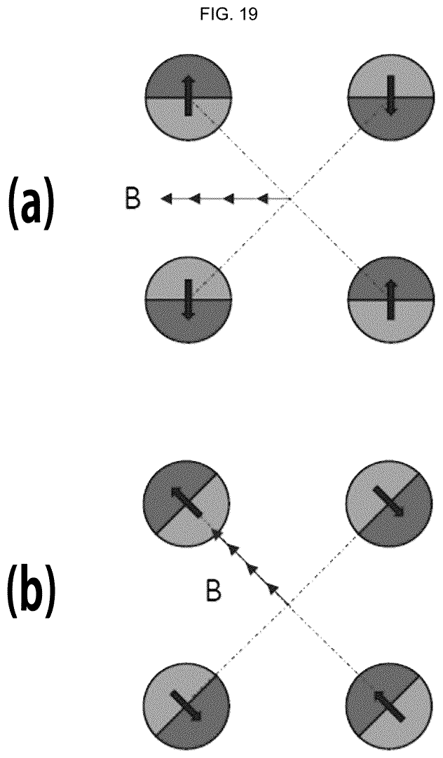

FIGS. 17 and 18 are perspective views of a driver for changing the direction of a magnetic field in a three-dimensional space according to another embodiment of the disclosure, and FIG. 19 illustrates change in the direction of a magnetic field based on a rotating direction of a magnet.

In this embodiment, the driver 200 may drive the magnet 100 to control the direction of the magnetic field applied to the LCE precursor solution material in three dimensional spatial directions.

In this embodiment, a driver 200 may include a rotary table 210, a rotary driver 215, and a rotation driver. The rotary table 210 and the rotary driver 215 have the same configurations as those of the foregoing embodiment. The rotation driver may be formed on the rotary table 210. The rotation driver drives a plurality of magnets 100, which are placed above the rotary table 210 and disposed around an axis perpendicular to the rotation axis of the rotary table 210, to rotate. In this case, the magnets 100 may be disposed equidistantly along the circumferential direction. According to this embodiment, four magnets 100 are disposed in the circumferential direction.

As shown in (a) of FIG. 19, when the four NS magnets 100 are disposed equidistantly in the circumferential direction and are disposed parallel to the axis perpendicular to the rotation axis of the rotary table 210, the magnetic fields respectively generated by the magnets 100 are combined at the center to form a magnetic field in the leftward direction as indicated by the arrows. In this case, as shown in (b) of FIG. 19, when the four magnets 100 are rotated at the same angle by a certain angle, the magnetic field at the center is formed in an upper left direction. In this way, controlling the rotation angle of the magnets 100 leads to the control of the magnetic field at the center in the circumferential direction where the magnets 100 are disposed.

Further, because the rotation driver is disposed on the rotary table 210, the direction of the magnetic field is controllable in the horizontal direction when the rotary driver 215 controls the rotation angle of the rotary table 210. Therefore, the direction of the magnetic field is controllable at the center in the three-dimensional direction when the rotation angle of the magnets 100 are controlled by the rotation driver together with the rotated position of the rotary table 210.

Therefore, according to this embodiment, the direction of the magnetic field is controlled not only in the horizontal direction but also in the three-dimensional spatial direction, thereby controlling the orientation direction of the liquid crystals in the three-dimensional direction.

For example, the rotation driver may include a worm gear 230 disposed horizontally and rotating by power received from a power source, a worm wheel 231 rotating being engaged with the worm gear 230, and a plurality of rotation gears 234 to which the magnets 100 are respectively coupled in the horizontal direction and which rotates being engaged with a gear train formed inside the through hole of the worm wheel 231. Therefore, when the worm gear 230 is rotated by a single power source, the worm wheel 231 rotates and the plurality of rotation gears 234 engaged with the gear train 2311 of the worm wheel 231 rotate in the same direction and at the same speed as the worm wheel 231. In this way, the magnets 100 respectively coupled to the rotation gears 234 may simultaneously rotate by the same angle.

In this case, spaces between the magnets 100 allow the light irradiated from the light source to reach the LCE precursor solution material disposed in the middle between the magnets.

The scope of the disclosure is not limited to the foregoing embodiments but may be implemented in various embodiments within the appended claims. Various modifications that any person having ordinary skill in the art to which the disclosure pertains can make without departing from the gist of the disclosure claimed in the appended claims are considered to be within the scope of the appended claims.

1. A liquid crystal elastomer (LCE) precursor solution material comprising photocurable reactive mesogen, EDDET (2,2′-(ethylenedioxy)diethanethiol), and 5CB (4-cyano-4-pentylbiphenyl).

2. The LCE precursor solution material of claim 1, wherein the photocurable reactive mesogen comprises either RM257 (1,4-Bis-[4-(3-acryloyloxypropyloxy)benzoyloxy]-2-methylbenzene) or RM82 (1,4-Bis-[4-(6-acryloyloxyhexyloxy)benzoyloxy]).

3. The LCE precursor solution material of claim 1, being prepared by dissolving powder of the photocurable reactive mesogen in solution of the 5CB at a temperature above room temperature, cooling the solution to room temperature, and adding the EDDET to the solution.

4. The LCE precursor solution material of claim 1, further comprising a photo-initiator (PI) and a photo-absorber (PA).

5. A photopolymerization apparatus for preparing a liquid crystal elastomer, comprising:
a magnet disposed around the liquid crystal elastomer precursor solution material of claim 1, and forming a magnetic field in liquid crystal elastomer precursor solution material to orient liquid crystal molecules;
a driver driving the magnet to control a direction of the magnetic field; and
a light source irradiating the liquid crystal elastomer precursor solution material with light to cure the liquid crystal elastomer precursor solution material by a photopolymerization reaction.

6. The photopolymerization apparatus of claim 5, wherein the magnet comprises a pair of magnets disposed to face each other with the liquid crystal elastomer precursor solution material therebetween.

7. The photopolymerization apparatus of claim 6, wherein the driver comprises:
a rotary table on which the pair of magnets are horizontally disposed to face each other; and
a rotary driver by which the rotary table is rotated.

8. The photopolymerization apparatus of claim 7, wherein the driver further comprises a distance controller to control a distance between the pair of magnets by moving at least one of the pair of magnets horizontally.

9. The photopolymerization apparatus of claim 5, wherein the driver drives the magnet to control the direction of the magnetic field formed in the liquid crystal elastomer precursor solution material in a three-dimensional direction.

10. The photopolymerization apparatus of claim 9, wherein the driver comprises:
a rotary table;
a rotary driver by which the rotary table is rotated; and
a rotation driver by which a plurality of magnets placed above the rotary table and disposed around an axis perpendicular to a rotation axis of the rotary table is driven to rotate.

11. The photopolymerization apparatus of claim 10, wherein the magnets are disposed equidistantly along a circumferential direction.

12. The photopolymerization apparatus of claim 10, wherein the magnets have a rotation axis disposed parallel to the axis perpendicular to the rotation axis of the rotary table.

13. The photopolymerization apparatus of claim 10, wherein the rotation driver comprises:
a worm gear disposed horizontally and rotating by power received from a power source;
a worm wheel which rotates being engaged with the worm gear; and
a plurality of rotation gears which rotate being engaged with a gear train formed inside a through hole of the worm wheel and respectively couple with the magnets.

14. The photopolymerization apparatus of claim 5, further comprising a digital micromirror device (DMD) and a digital mask to form a pattern by selectively reflecting the light irradiated from the light source toward the liquid crystal elastomer precursor solution material.
